(19) United States
(12) Patent Application Publication
(10) Pub. No.: US 2006/0087751 A1
(43) Pub. Date: Apr. 27, 2006

(54) OPTICAL LENS SYSTEM AND ITS ASSEMBLY PROCESS

(76) Inventors: Chia-Cheng Liu, Taichung County (TW); Jen-Chen Chuang, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/905,765

(22) Filed: Jan. 20, 2005

(30) Foreign Application Priority Data
Oct. 26, 2004 (TW) 93132322

(51) Int. Cl. G02B 7/02

(52) U.S. Cl. 359/819

(57) ABSTRACT

An optical lens system includes a first lens barrel, a second lens barrel, multiple lenses and multiple fixing components. The first barrel contains a first lens disposing space and a first outer ring part surrounding the first lens disposing space. The first outer ring part is formed with indentations. Additionally, the second barrel contains a second lens disposing space and a second outer ring part, which surrounds the second lens disposing space. The second outer ring part is formed with protrusions. The second outer ring part is engaged to the first outer ring part, the protrusions is inserted to the indentations with loose fit. Furthermore, the lenses are disposed in the first lens disposing space and the second lens disposing space respectively. The fixing components are disposed on the first outer ring part and the second outer ring part to affix these two barrels with each other.

### CROSS-REFERENCE TO RELATED APPLICATION

This application claims the priority benefit of Taiwan application serial no. 93132322, filed Oct. 26, 2004.

### BACKGROUND OF THE INVENTION

1. Field of Invention

The present invention relates to a lens system and its assembly process. More particularly, the present invention relates to an optical lens system and its assembly process.

2. Description of the Prior Art

In today's information society, people in daily life cannot be separated from the variety optical system, for example, telescope, camera, microscope and optical projection system. For these optical systems the lens plays a decisive role for image quality. The conventional optical lens system is further described.

FIG. 1 is a cross-sectional view, schematically illustrating the conventional optical lens. Referring to FIG. 1, the conventional optical lens system 100 includes a first lens-barrel 110, a second lens-barrel 120, a plurality of lenses 130 and a plurality of fixing screws 140. The first lens-barrel 110 has a first lens disposing space 110a and a first outer ring part 112 which is surrounding the first lens disposing space 110a, wherein the first outer ring part 112 is formed with a plurality of indentations 112a. In addition, the second lens-barrel 120 has a second lens disposing space 120a and a second outer ring part 122 which is surrounding the second lens disposing space 120a, wherein the second outer ring part 122 is formed with a plurality of protrusions 122a.

It's noticeable that the second outer ring part 122 is engaged to the first outer ring part 112, and the protrusions 122a are engaged with the indentations 112a in tight fit. Also and, the lenses 130 are disposed within the first lens disposing space 110a and the second lens disposing space 120a. Moreover, the fixing screws 140 are located on the first outer ring part 112 and the second outer ring part 122, to fix a required relative position between the first lens-barrel 110 and the second lens-barrel 120.

As described above, the relative position accuracy between the first lens-barrel 110 and the second lens-barrel 120 is the key for the conventional optical lens system 100. In other words, the working accuracy of protrusions 122a and the indentations 112a determines the aligning accuracy between the first lens-barrel 110 and the second lens-barrel 120. Since the protrusions 122a and the indentations 112a have the fabrication error, an eccentric shifting between the optic axis of the first lens-barrel 110 and the optic axis of the second lens-barrel 120 occurs. The degree of the eccentric shifting, as a result, then determines the optical property of the conventional optical lens system 100. In addition, since the protrusions 122a is engaged with the indentations 112a by the tight fit manner, a conventional optical lens system 100 with relatively larger eccentric shifting cannot be reworked, and becomes a defect product.

### SUMMARY OF THE INVENTION

It is an object of the invention to provide an optical lens system for improving alignment precision between the first lens barrel and the second lens barrel.

In another object of the invention is to provide a assembly process for the optical lens system, so that the yield rate of lens assembling process is increased.

In accordance with the foregoing objects or the others, the present invention provides an optical lens system, which can be center-adjustable and comprises a first barrel, a second barrel, a plurality of lenses and a plurality of fixing components. The first barrel comprises a first lens disposing space and a first outer ring part which surrounding the first lens disposing space, wherein the first outer ring part is equipped with a plurality of indentations. Additionally, the second barrel contains a second lens disposing space and a second outer ring part surrounding the second lens disposing space, wherein the second outer ring part is formed with a plurality of protrusions. Further, the second outer ring part is engaged with the first outer ring part, and the protrusions is inserted to the indentations with loose fit. Furthermore, the lenses are disposed in the first lens disposing space and the second lens disposing space, respectively. The fixing components are located at both of the first outer ring part and the second outer ring part to affix these two barrels with each other.

In accordance with the preferred embodiment description, the fixing components can be, for example, screws.

Alternatively, in accordance with the preferred embodiment description, the fixing components can be, for example, bolts and nuts.

Also, in accordance with the preferred embodiment description, the inclination angle between the contiguous protrusions can be, for example, 120 degree.

In accordance with the objects or the others, the present invention provides an assembly process for the lens system, which can be center-adjustable. This assembly process comprises the following steps. First, an optical projection jig is provided. The projection jig comprises a light source, a collecting module and a testing plate. Wherein, the collecting module is disposed at the optic path between the light source and the testing plate, on which a chart is formed. The projection jig is employed to project the chart on the testing plate onto a screen. Furthermore, the first barrel with a built-in set of lenses is fixed in the projection jig. The second barrel is disposed on the first barrel, and the other portion of lenses has been implemented in the second lens barrel, wherein the indentations and the protrusions are engaged with each other. Then, a relative position between the first barrel and the second barrel is adjusted to get a sharp chart image being projected onto the screen. Then, the fixing components are used to fix the relative position between the second barrel and the first barrel.

In accordance with the preferred embodiment of the present invention, after adjusting the relative position between the second barrel and the first barrel and before using the fixing components, the assembly process for the optical lens system further comprises using a fixing glue to fix both of the first barrel and the second barrel.

In accordance with the preferred embodiment description of the present invention, the chart can be, for example, cross mark, rectangular mark or circle mark etc.

As above-mentioned, the optical lens of the present invention uses a loose fit manner to engage the protrusions with the indentations, so that the relative position accuracy between the first barrel and the second barrel is not limited by the manufacturing accuracy of the first barrel and the second barrel. In addition, since the loose fit is used for engaging the protrusions and the indentations, the assembly process of the optical lens system in the present invention, allow a higher relative position accuracy between the first barrel and the second barrel.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view, schematically showing the conventional optical lens system.

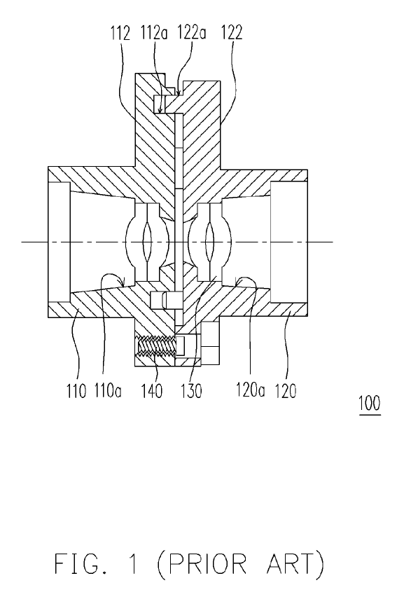

FIG. 2 is a cross-sectional view, schematically showing the optical lens system, according to an embodiment of the invention.

FIG. 3 is a drawing, schematically illustrating a assembly process of the optical lens system, according to a preferred embodiment of the invention.

FIG. 4 is a top view, schematically illustrating the testing plate used in assembly of the optical lens system, according to a preferred embodiment of the invention.

### DESCRIPTION OF EMBODIMENTS

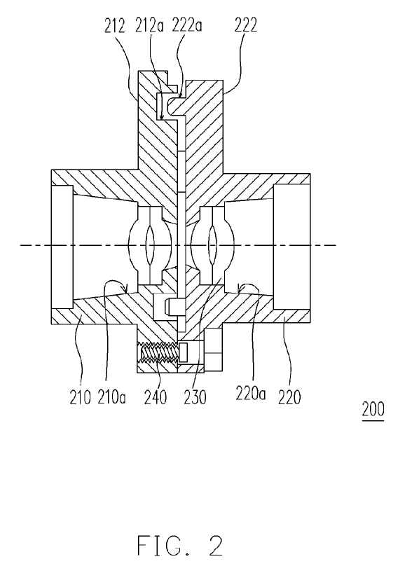

FIG. 2 is a cross-sectional view, schematically showing the optical lens system, according to an embodiment of the invention. In FIG. 2, the optical lens system 200 includes a first barrel 210, a second barrel 220, multiple lenses 230 and multiple fixing components 240. The first barrel 210 includes a first lens disposing space 210a and a first outer ring part 212 surrounding the first lens disposing space 210a. Wherein, the first outer ring part 212 is formed with a plurality of indentations 212a. Additionally, the second barrel 220 includes a second lens disposing space 220a and a second outer ring part 222 surrounding the second lens disposing space 220a. Wherein, the second outer ring part 222 is formed with a plurality of protrusions 222a.

Remarkably, the second outer ring part 222 is held against the first outer ring part 212. The protrusions 222a and the indentations 212a are engaged to each other by loose fit. In another words, the diameter of protrusions 222a is smaller than the diameter of indentations 212a. Furthermore, the dimension match of the protrusions 222a and the indentations 212a can be based on shaft basis system or hole basis system, so that the protrusions 222a are engaged with the indentations 212a by the loose fit manner. The shaft basis system means that axis tolerance remains the same for the same level of tolerance, and the hole being used determines the tolerance. In other words, the axis-diameter is used as the base of size and the hole-diameter is determined according to the level being associated. In addition, the hole basis system means that the hole tolerance remains the same for the same level of tolerance, and the different tolerance for the axis being used is determined. In other words, the hole-diameter is used as the base of size and axis-diameter is determined according to the level being associated. Moreover, the including angle between the adjacent two protrusions 222a can be 120 degree, for example, but the present invention doesn't restrict the number of the protrusions 222a or their layout.

In FIG. 2, the lenses 230 are disposed in the first lens disposing space 210a and the second lens disposing space 220a, respectively. It should be noted that the lenses 230 is not limited to type, quantity and disposing positions from those shown in FIG. 2. And, the fixing components 240 are, for example, located at the first outer ring part 212 and the second outer ring part 222 to fix the first barrel 210 and the second barrel 220 together. In the embodiment, the fixing components are, for example, screws, but the fixing components 240 can also be bolts and nuts, any component for coupling the first lens barrel 210 and the second lens barrel 220 or other fixing components to fix the relative position between the first barrel 210 and the second barrel 220.

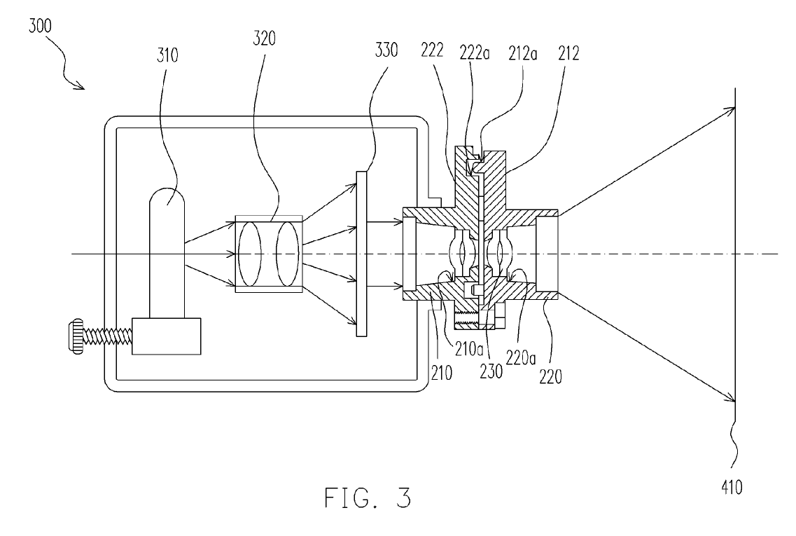

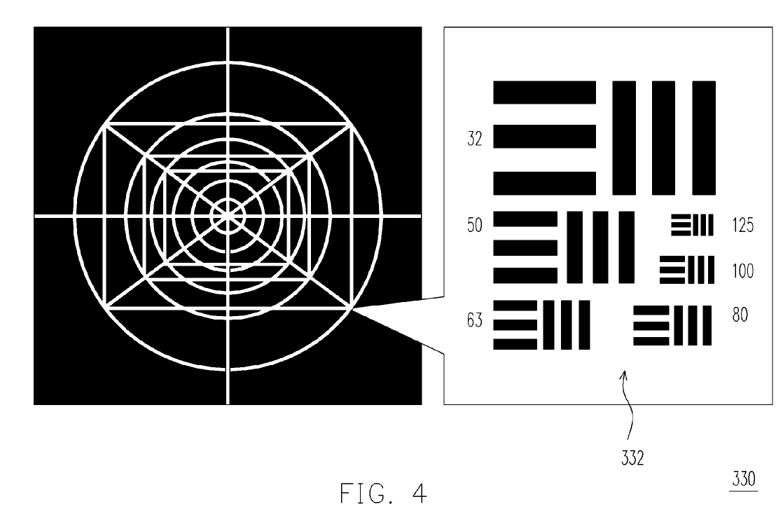

FIG. 3 is a drawing, schematically illustrating a assembly process of the optical lens system, according to a preferred embodiment of the invention, and FIG. 4 is a top view, schematically illustrating the testing plate used in assembly of the optical lens system, according to a preferred embodiment of the invention. In FIG. 3 and FIG. 4, the lens assembly process of the optical lens system includes the following steps. First, a projection jig 300 is provided. The projection jig 300 includes a light source 310, a collecting module 320, and a testing plate 320. The collecting module 320 is located at the optic path between light source 310 and testing plate 330. In addition, the testing plate 330 is formed with an image chart 332 thereon, as shown in FIG. 4. The chart 332 at testing plate 330 can be projected onto the screen 410 by the emitted light from light source 310. The foregoing chart 332 at the testing plate 330 can be, for example, cross mark, rectangular mark, circle mark or the other simple ones.

Then, the first barrel 210 is fixed onto the projection jig 300, and the lenses 230 have been disposed in the first barrel 210 already. Then the second barrel 220 with implementation of the lenses 230 is disposed on the first barrel 210, making the protrusions 222a and the indentations 212a engaged with each other, to complete a primary positioning between the first barrel 210 and the second barrel 220.

Then, still referring to FIG. 3, since the protrusion 222a is engaged with the indentations 212a by the loose fit manner, the assembling person can adjust the relative positions between the second barrel 220 and the first barrel 210 until the chart 322 being projected onto the screen 410 is the most clear. At this moment, the eccentric shifting between the optic axis of first barrel 210 and the optic axis of second barrel 220 is at the minimum, and then the alignment between the first barrel 210 and the second barrel 220 is completed. Then, the relative positions between the second barrel 220 and the first barrel 210 are fixed by the fixing components 240, as shown in FIG. 2. It should be noted that a fixing glue (not shown in the drawings) can be further used to fix the first barrel 210 and the second barrel 220, after accomplishing the alignment between the first barrel 210 and the second barrel 220, so as to easily use the fixing components 240.

In comparison with the conventional technology, the first barrel and the second barrel of optical lens system in the invention are positioned by a projection jig, therefore these lens barrels of the invention have netter alignment accuracy. In another word, in comparison with the conventional technology, the optical lens system of the present invention has better optic performance.

In comparison, the conventional optical lens system, in which the alignment accuracy of the first lens barrel and the second lens barrel is limited to the fabrication accuracy of the first lens barrel and the second lens barrel. The protrusions of the optical lens system of the present invention use the loose-fit manner to engage the indentations, and the projection jig is used to align the first lens barrel and the second lens barrel. As a result, the alignment accuracy of the first lens barrel and the second lens barrel is not limited to the fabrication accuracy of the first lens barrel and the second lens barrel. In another words, in comparing with the convention technology, the fabrication accuracy for the first lens barrel and the second lens barrel of the optical lens system is looser, therefore the fabrication cost of the optical lens system of the invention can be further reduced.

In comparing the conventional skill, since the protrusions of the optical lens system of the invention is engaged with the indentations by the loose-fit manner, the optical lens system of the invention can be reworked, so that the yield rate of the optical lends system can be further improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A center-adjustable optical lens system, comprising:
a first barrel, having a first lens disposing space and a first outer ring part surrounding the first lens disposing space, wherein the first outer ring part comprises a plurality of indentations;
a second barrel, having a second disposing space and a second outer ring part surrounding the second lens disposing space, wherein the second outer ring part comprises a plurality of protrusions, wherein the second outer ring part is engaged with the first outer ring part, and the protrusions and the indentations are engaged by loose fit;
a plurality of lenses, disposed in the first lens disposing space and the second lens disposing space; and
a plurality of fixing members, located on the first outer ring part and the second outer ring part to fix the first barrel and the second barrel.

2. The center-adjustable optical lens system of claim 1, wherein when the protrusions and the indentations of the first outer ring part and the second outer ring part are engaged, due to an effect of loose fit, the barrels can be relatively moved under an engaged state between the protrusions and the indentations, before fixing members are affixed to the first and the second outer ring parts.

3. The center-adjustable optical lens system of claim 1, wherein the fixing components include screws.

4. The center-adjustable optical lens system of claim 1, wherein the fixing components include bolts and nuts.

5. The center-adjustable optical lens system of claim 1, wherein an including angle between the adjacent two protrusions is 120 degree.

6. A center-adjustable assembly process for the optical lens system as recited in claim 1, the assembly process comprising:
providing a projection jig, the projection jig comprising a light source, a collecting module and a testing plate, wherein the collecting module is disposed at an optic path between the light source and the testing plate, a chart is formed on the testing plate, and the projection jig is used to project the chart onto a screen;
fixing the first barrel on the projection jig, and a portion of the lenses has been disposed in the first barrel already;
disposing the second barrel on the first barrel, and the other portion of the lenses has bee disposed in the second barrel already, wherein the protrusions are engaged with the indentations, respectively;
adjusting a relative position between the second barrel and the first barrel to make the chart be clearly projected onto the screen; and
using the fixing components to fix the relative position between the second barrel and the first barrel.

7. The center-adjustable assembly process of claim 6, wherein, after adjusting the relative position between the second barrel and the first barrel but before using the fixing components, further using a fixing glue to fix the first barrel and the second barrel.

8. The assembly process of claim 6, wherein the chart includes cross mark, rectangular mark or circle mark.
